(19) United States
(12) Patent Application Publication
(10) Pub. No.: US 2024/0020334 A1
(43) Pub. Date: Jan. 18, 2024

(54) AUDIO WITH EMBEDDED TIMING FOR SYNCHRONIZATION

(71) Applicant: QUALCOMM Incorporated, San Diego, CA (US)

(72) Inventors: Richard Barron FRANKLIN, San Diego, CA (US); Christopher Alan PAGNOTTA, Carlsbad, CA (US); Justin Joseph Rosen GAGNE, San Diego, CA (US); Jeffrey PAYNE, Lakeside, CA (US); Stephen James POTTER, San Diego, CA (US); Bengt Stefan GUSTAVSSON, Rancho Santa Fe, CA (US)

(21) Appl. No.: 18/352,867

(22) Filed: Jul. 14, 2023

Related U.S. Application Data
(60) Provisional application No. 63/390,217, filed on Jul. 18, 2022.

(51) Int. Cl. G06F 16/687; H04R 3/00; G06F 16/68

(52) U.S. Cl. CPC G06F 16/687; H04R 3/005; G06F 16/686

(57) ABSTRACT

Techniques are described herein for audio processing. For instance, a technique can include receiving, from one or more microphones, an audio signal; receiving a periodic timing signal based on the periodic timing signal; combining the audio signal and the periodic timing signal into an audio stream; generating a time stamp based on the received periodic timing signal; and adding the generated time stamp to the audio stream based on the periodic timing signal in the audio stream.

### CROSS-REFERENCE TO RELATED APPLICATIONS

This application claims the benefit of U.S. Provisional Application No. 63/390,217, filed Jul. 18, 2022, which is hereby incorporated by reference, in its entirety and for all purposes.

### FIELD

The present disclosure generally relates to audio processing (e.g., generating a digital audio stream or file from audio input and/or decoding the digital audio stream or file to audio data). For example, aspects of the present disclosure are related to systems and techniques for generating audio with embedded timing information for synchronization, such as across devices.

### BACKGROUND

Audio synchronization generally refers to a technique whereby audio recordings or samples obtained from multiple sources are aligned in time. For example, a device having multiple microphones may generate an audio recording for each microphone. Sound waves may arrive at the microphones of the multiple microphones of the device at a slightly different time and it may be desirable to synchronize the audio recordings for the multiple microphones, for example, to generate a single audio stream with potentially better quality than with a single microphone. As another example, audio recordings made on multiple devices across multiple microphones on the same device be synchronized in time to help determine exactly when each microphone received a particular sound wave. Such time synchronization may help determine an angle of arrival for the sound wave, which can be useful for locating where a sound is coming from, or for combining sounds across devices to form large microphone arrays. Time synchronization across microphones of multiple devices can introduce challenges.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below

Systems and techniques are described for audio processing. In one illustrative example, an apparatus for audio processing comprising: a receiver configured to output a periodic timing signal; one or more microphones; a microphone interface coupled to the receiver and coupled to the one or more microphones, wherein the microphone interface is configured to: receive, from the one or more microphones, an audio signal; and receive, from the receiver, the periodic timing signal; and one or more processors coupled to the microphone interface and coupled to the receiver, wherein the one or more processors are configured to: combine the audio signal and the periodic timing signal into an audio stream; generate a time stamp based on the received periodic timing signal; and add the generated time stamp to the audio stream based on the periodic timing signal in the audio stream.

In another illustrative example, a method for audio processing comprising: receiving, from one or more microphones, an audio signal; receiving a periodic timing signal based on a periodic timing signal; combining the audio signal and the periodic timing signal into an audio stream; generating a time stamp based on the received periodic timing signal; and adding the generated time stamp to the audio stream based on the periodic timing signal in the audio stream.

In another illustrative example, a non-transitory computer-readable medium having stored thereon instructions that, when executed by one or more processors, cause the one or more processors to: receive, from one or more microphones, an audio signal; receive periodic timing signal based on a periodic timing signal; combine the audio signal and the periodic timing signal into an audio stream; generate a time stamp based on the received periodic timing signal; and add the generated time stamp to the audio stream based on the periodic timing signal in the audio stream.

In another illustrative example, an apparatus for audio processing comprising: means for receiving, from one or more microphones, an audio signal; means for receiving a periodic timing signal based on the periodic timing signal; means for combining the audio signal and the periodic timing signal into an audio stream; means for generating a time stamp based on the received periodic timing signal; and means for adding the generated time stamp to the audio stream based on the periodic timing signal in the audio stream.

In some aspects, the apparatus comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 illustrates an example implementation of a system-on-a-chip (SOC), in accordance with some examples;

FIG. 2 is a block diagram illustrating reception of an audio signal using separate microphones, in accordance with aspects of the present disclosure;

FIG. 3 is a block diagram of an example audio device for generating audio with embedded timing information, in accordance with aspects of the present disclosure;

FIG. 4 is a flow diagram illustrating a technique for generating audio with embedded timing information for synchronization, in accordance with aspects of the present disclosure;

FIG. 5 illustrates an example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

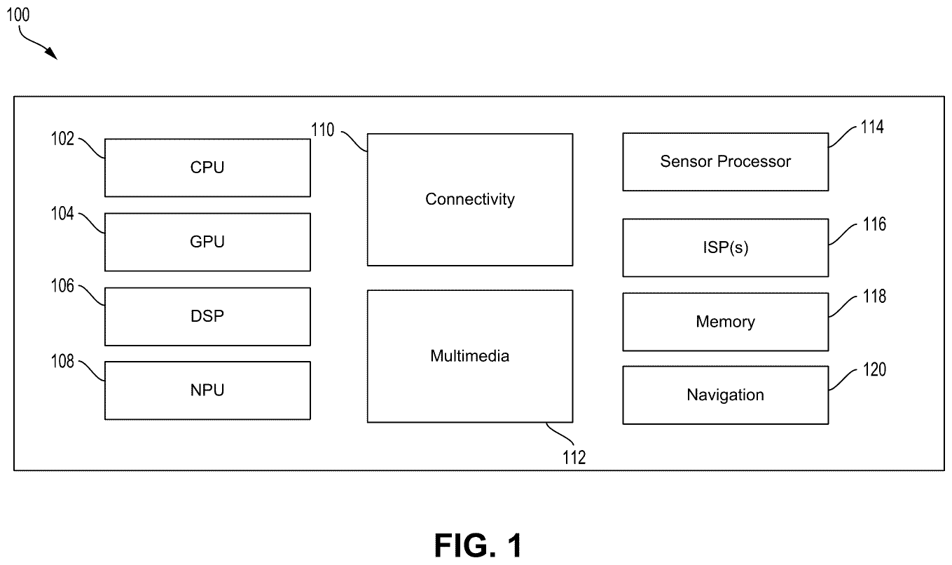

Various aspects of the present disclosure will be described with respect to the figures. FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

SOC 100 and/or components thereof may be configured to perform audio capture with embedding timing. For example, the sensor processor 114 may receive and/or process audio input from sensors, such as one or more microphones (not shown) of a device. In some cases, the sensor processor 114 may also receive, as audio input, output of one or more processing blocks of the connectivity block 110. Additional processing of the audio input may be performed by other components of the SOC 100 such as the CPU 102, DSP 106, and/or NPU 108.

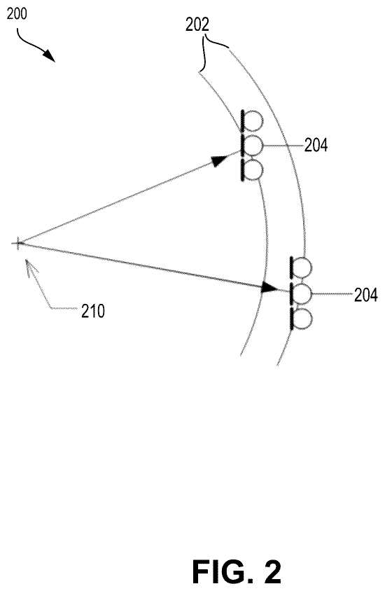

FIG. 2 illustrates an example 200 for estimating a direction of an audio event. For estimating a direction from which an audio event originated from an audio source 210, it is desirable to obtain widely separated audio recordings. For example, sound waves 202 may arrive at very close in time when two (or more) closely spaced microphones 204 are used. When closely spaced microphones are used, very precise timing information may be needed to determine a direction of the sound wave. However, for more widely spaced (e.g., an increased baseline) microphones, there would be more time between the arrival of the sound wave at the different microphones. This increased time could allow for less precise timing measurements to be used and/or significantly increased accuracy.

Generally, audio synchronization across multiple audio inputs, such as multiple microphones, on a single device is straight forward as a single clock source of the device may be used to obtain timing information across the multiple microphones. However, there is a practical limit due to device size constraints, especially for portable devices, for how far away microphones on a single device may be. A more accurate calculation can be made by multiple devices that are separated by relatively large distances.

In some cases, synchronizing audio information recorded on multiple devices helps increase the baseline between microphones. However, combining the data across devices may depend upon aligning the audio samples using a common timing reference. Furthermore, even when timing reference signals are available on multiple devices, there may be unknown delays within the individual devices that could cause errors in determining the exact time when an audio source was sampled. Therefore, it may be difficult to synchronize audio information across multiple devices as these multiple devices may not share a common clock source.

In accordance with aspects of the present disclosure, systems and techniques are described for providing a common timing reference embedded or included with audio data. The common timing references may be any periodic signal. Illustrative examples of periodic signals include, but are not limited to, certain global positioning system (GPS) signals, Wi-Fi signals (e.g., Wi-Fi beacons), Bluetooth signals, cellular signals, etc.

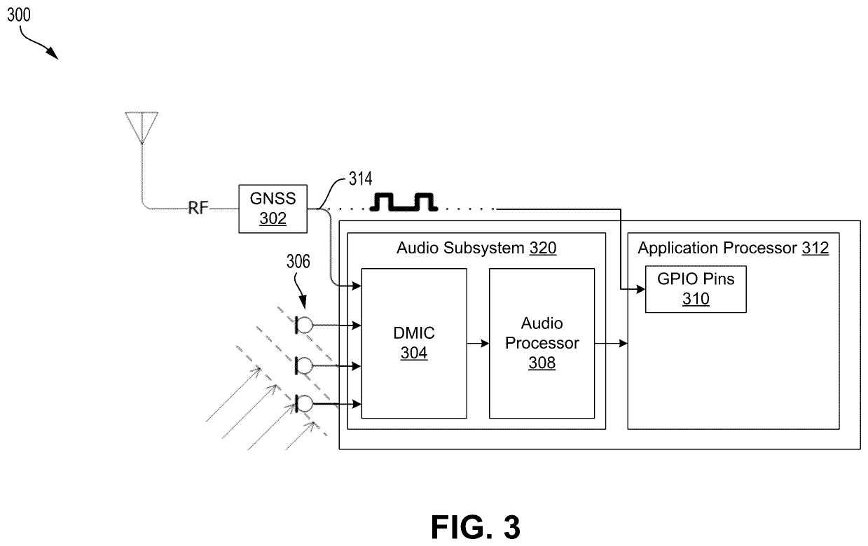

FIG. 3 is a block diagram of an example audio device 300 for generating audio with embedded timing information, in accordance with aspects of the present disclosure. The audio device 300 may include an audio subsystem 320, Global Navigation Satellite System (GNSS) receiver(s) 302, one or more microphones 306, and an application processor 312. The audio subsystem 320 may include a digital microphone interface (DMIC) 304 for receiving audio signals from the one or more microphones 306 and an audio processor 308 for processing the received audio signals. The application processor 312 may be any general purpose processor, such as a CPU, core of a multi-core CPU, etc. The application processor 312 may include an input interface, such as one or more general purpose input/output (GPIO) pins 310. In some cases, the DMIC 304 and audio processor 308 may be included as a part of the sensor processor 114 of FIG. 1. The GPS 1PPS signal may also be input to one or more general purpose I/O (GPIO) pins 310 of an application processor 312 (e.g., CPU 102, DSP 106, and/or NPU 108 of FIG. 1). In some cases, the audio subsystem 320 and the application processor 312 may be integrated on a single chip, such as a SoC

In some cases, the GNSS receiver(s) 302 may include one or more GNSS receivers or transceivers that are used to determine a location of the audio device 300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. In this example, the GNSS receiver(s) 302 may receive a GPS signal and produce a periodic timing signal, such as a one pulse per second (1PPS) signal 314. The GPS 1PPS may have a pulse width of 100 ms. While a GNSS/GPS signal is used as an illustrative example of a commonly found reference signal that may be used as a timing signal in FIG. 3, any other commonly found reference signal may be used, such as Wi-Fi signals (e.g., Wi-Fi beacons, announcement signals, etc.), Bluetooth signals, cellular signals, etc.

In accordance with aspects of the present disclosure, the GPS 1PPS signal may be fed into a microphone input, such as the digital microphone (DMIC) input 304 as an audio input. Feeding the GPS 1PPS signal as an audio input embeds the GPS 1PPS signal as a sound signal indicating timing information (e.g., a pulse every second) into the audio sample stream. In some cases, the embedded GPS 1PPS sound signal in an audio stream may be characterized as a waveform of a certain set frequency and amplitude (e.g., sound) that, upon playback of the audio sample stream, may sound like a tone, pulse, beep, click, or other periodic sound in the audio sample stream that occurs once each second and lasts for 100 ms.

When the age of the samples is to be determined with respect to GPS time (e.g., by the application processor 312), the exact audio sample coinciding with the pulse each second (from the 1PPS signal) can be determined by processing the audio stream to locate the embedded GPS 1PPS sound. As the audio stream receives audio samples at a specific rate, a 1PPS signal may be useful to determine the “true” sample rate (e.g., by counting the audio samples between instances of the 1PPS signal) and the 1PPS signal provides a high resolution timing indicator (e.g., clock reference) across all received audio streams.

As noted above, in some cases, the GPS 1PPS signal (clock) reference 314 may be input to an input port of the DMIC input 304 (e.g., or other digital or analog audio front end). The DMIC 304 may also be coupled to one or more microphones 306 and may receive audio signals from the one or more microphones 306. The DMIC 304 may be coupled to an audio processor 308, such as an audio DSP. In some cases, the audio samples from multiple microphone inputs (e.g., for all of the microphones 306 and the GPS 1PPS signal input to the DMIC 304) of the device may be synchronized by the audio subsystem 320 (e.g., by the DMIC 304 and/or audio processor 308) to produce a single audio stream that may be output to the application processor 312. For example, an audio device, such as audio device 300, may include multiple microphones 306 and an audio signal received from each microphone may have a different amount to latency between when the audio signal is received by the microphone and when the audio signal reaches the DMIC 304, and the audio subsystem 320 may be configured to correct for this difference in latency (e.g., latency correction).

Assuming sample synchronization (e.g., latency correction) within the audio device 300, the embedded timing information derived from one microphone input can be applied to the audio samples from all microphones 306 on the same audio device 306. Unlike traditional methods, this approach does not introduce unknown delays or jitter as opposed to comparing the explicit timing data from the GPIO pins (e.g., the GPIO pins 310) with audio samples that may have come across a bus, for example, from a different processor (e.g., that may occur if the application processor 312 is trying to directly apply timing data received from the GNSS 302 to audio samples/stream from the audio sub-system). Here, the audio processor may output an audio stream with the timing information embedded in the audio stream.

In some cases, the audio stream with the embedded timing information from the audio processor 308 may be input to the application processor 312. As indicated above, the application processor 312 may also receive the GPS 1PPS signal 314. The application processor 312 may also receive additional GPS information such as location and time of week (TOW) information. In one illustrative example, the GPS TOW information may be a 10-bit number indicating a week number based on a defined week zero of the GPS system, along with an elapsed number of seconds for the week. The application processor 312 may extract the embedded timing information from the audio stream and use the timing information to synchronize the audio stream with the TOW information. Time stamps may be generated based on the TOW information and these time stamps may be attached to the audio stream, for example, as metadata labels corresponding to the synchronized timing. In some cases, the location information may additionally or alternatively be added to the audio stream, for example, as metadata.

When augmented with the TOW that is independently available from the GPS receiver 302, a proper GPS time stamp can be created, for example, by the application processor 312. After the time stamp is added to the audio stream, peer devices can exchange location information as well as timing information related to audio events that can be aligned correctly in time. For example, for a particular audio event, multiple peer devices which detected the audio event may exchange timing information indicating when they detected the audio event. As the multiple peer devices are synchronized based on the common timing signal (e.g., the GPS 1PSS timing signal), the exchanged timing information may be already aligned (e.g., synchronized) and any difference in when the audio event is heard by the peer devices may be based on the location of the peer device with respect to the audio source (e.g., audio source 210 of FIG. 2) of the audio event.

Each device may then perform certain operations based on the synchronization. In one illustrative example, one or more devices of the peer devices, such as audio device 300, may perform a time difference of arrival (TDOA) calculation to estimate the position of the audio source (e.g., the audio source 210 shown in FIG. 2), as microphone location, device relative position, and audio timing are known through the exchanged timing information and location information (for the peer devices). Note that large separation distances allow the calculation to be orders of magnitude more accurate than a smaller array on a single device (e.g., as shown in FIG. 3). In another illustrative example, the periodic timing signal may be used to combine audio streams for many other purposes, such as for improving a fidelity of an audio recording of a musical performance when captured by multiple recording devices from many different locations.

In some aspects, in addition to or as an alternative to using a GPS 1PSS signal as a reference or timing signal for synchronization, a Wi-Fi signal (e.g., a Wi-Fi timing beacon, announcement beacon, or other periodic beacon) may be used to embed timing information into the audio stream. For example, a Wi-Fi system may broadcast an announcement and/or beacon signal periodically (e.g., at a regular interval) and this beacon signal may be detectable by multiple devices near the Wi-Fi system. This beacon signal may be used as a reference signal for synchronizing multiple audio devices, such as audio device 300 of FIG. 3. In some cases, pre-processing (e.g., to reduce a frequency, signal width, etc. of the signal) may be applied to allow the Wi-Fi signal to fit into a low bandwidth audio signal.

In another aspect, periodic cellular signals may be used to embed timing information into the audio stream. Cellular signals may include those signals used for broadband wireless communications systems, including, but not limited to first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of broadband wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. As an example of embedding a cellular signal in an audio stream, a vehicle to everything (V2X) standard (which may be based on 4G LTE and/or NR standards) includes periodic beacons that are sent at a rate of 10 Hz. When appropriately preprocessed, this may be a low enough of a pulse rate to be fed into an audio input as a periodic timing signal.

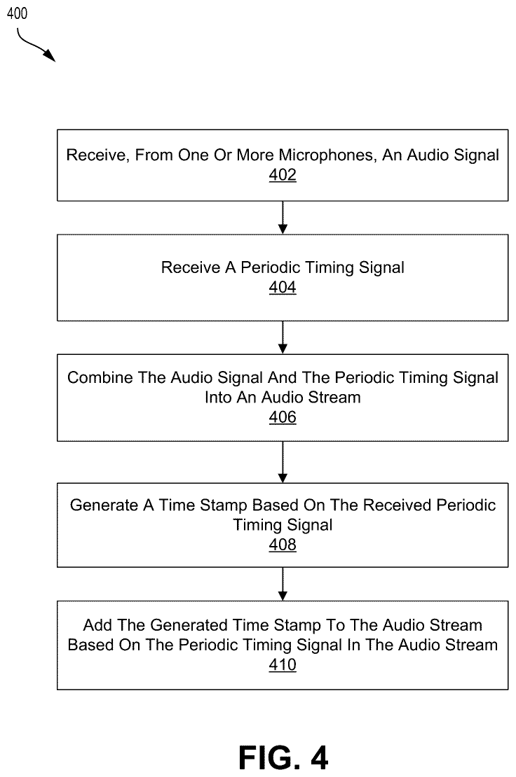

FIG. 4 is a flow diagram illustrating a process 400 for generating audio with embedded timing information for synchronization, in accordance with aspects of the present disclosure. At operation 402, process 400 can include receiving, from one or more microphones, an audio signal. At operation 404, process 400 can include receiving a periodic timing signal. In some cases, the periodic timing signal is received from a global positioning system (GPS) or other Global Navigation Satellite System receiver. In some cases, the periodic timing signal comprises a one pulse per second signal received by the GPS receiver. In some cases, the periodic timing signal is received from a Wi-Fi receiver. In some cases, the periodic timing signal is received from a cellular receiver.

At operation 406, process 400 can include combining the audio signal and the periodic timing signal into an audio stream. At operation 408, process 400 can include generating a time stamp based on the received periodic timing signal. In some cases, process 400 can also include receiving a time of week signal from the GPS receiver and generating the time stamp based on the time of week signal and the periodic timing signal. In some cases, the generated time stamp is added as metadata to the audio stream.

At operation 408, process 400 can include adding the generated time stamp to the audio stream based on the periodic timing signal in the audio stream. In some cases, process 400 can further include obtaining first location information associated with the one or more microphones and outputting the first location information and audio stream for transmission to another device. In some cases, process 400 can also include obtaining first location information associated with the one or more microphones, receiving an additional audio stream with time stamps and second location information, and identifying a location of an audio event based on the first location information, the second location information, the audio stream with the generated time stamp, and the additional audio stream with time stamps.

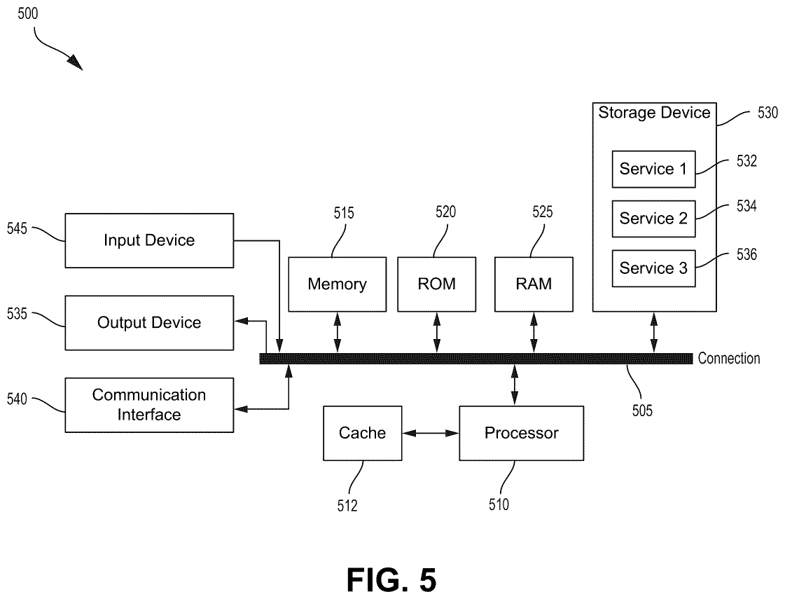

FIG. 5 illustrates an example computing device architecture 500 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing device architecture 500 may include SOC 100 of FIG. 1 and/or audio device 300 of FIG. 3. The components of computing device architecture 500 are shown in electrical communication with each other using connection 505, such as a bus. The example computing device architecture 500 includes a processing unit (CPU or processor) 510 and computing device connection 505 that couples various computing device components including computing device memory 515, such as read only memory (ROM) 520 and random access memory (RAM) 525, to processor 510.

Computing device architecture 500 can include a cache of high-speed memory connected directly with, in close proximity to, or integrated as part of processor 510. Computing device architecture 500 can copy data from memory 515 and/or the storage device 530 to cache 512 for quick access by processor 510. In this way, the cache can provide a performance boost that avoids processor 510 delays while waiting for data. These and other modules can control or be configured to control processor 510 to perform various actions. Other computing device memory 515 may be available for use as well. Memory 515 can include multiple different types of memory with different performance characteristics. Processor 510 can include any general purpose processor and a hardware or software service, such as service 1 532, service 2 534, and service 3 536 stored in storage device 530, configured to control processor 510 as well as a special-purpose processor where software instructions are incorporated into the processor design. Processor 510 may be a self-contained system, containing multiple cores or processors, a bus, memory controller, cache, etc. A multi-core processor may be symmetric or asymmetric.

To enable user interaction with the computing device architecture 500, input device 545 can represent any number of input mechanisms, such as a microphone for speech, a touch-sensitive screen for gesture or graphical input, keyboard, mouse, motion input, speech and so forth. Output device 535 can also be one or more of a number of output mechanisms known to those of skill in the art, such as a display, projector, television, speaker device, etc. In some instances, multimodal computing devices can enable a user to provide multiple types of input to communicate with computing device architecture 500. Communication interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. Storage device 530 can include services 532, 534, 536 for controlling processor 510. Other hardware or software modules are contemplated. Storage device 530 can be connected to the computing device connection 505. In one aspect, a hardware module that performs a particular function can include the software component stored in a computer-readable medium in connection with the necessary hardware components, such as processor 510, connection 505, output device 535, and so forth, to carry out the function.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors, and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific embodiments. For example, a system may be implemented on one or more printed circuit boards or other substrates, and may have movable or static components. While the below description and examples use the term “system” to describe various aspects of this disclosure, the term “system” is not limited to a specific configuration, type, or number of objects.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as flash memory, memory or memory devices, magnetic or optical disks, flash memory, USB devices provided with non-volatile memory, networked storage devices, compact disk (CD) or digital versatile disk (DVD), any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASIC s), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: An apparatus for audio processing comprising: a receiver configured to output a periodic timing signal; one or more microphones; a microphone interface coupled to the receiver and coupled to the one or more microphones, wherein the microphone interface is configured to: receive, from the one or more microphones, an audio signal; and receive, from the receiver, a periodic timing signal based on the periodic timing signal; and one or more processors coupled to the microphone interface and coupled to the receiver, wherein the one or more processors are configured to: combine the audio signal and the periodic timing signal into an audio stream; generate a time stamp based on the received periodic timing signal; and add the generated time stamp to the audio stream based on the periodic timing signal in the audio stream.

Aspect 2. The apparatus of claim 1, wherein the receiver comprises a global positioning system (GPS) receiver.

Aspect 3. The apparatus of claim 2, wherein the periodic timing signal comprises a one pulse per second signal received by the GPS receiver.

Aspect 4. The apparatus of any one of claim 2 or 3, wherein the one or more processors are further configured to: receive a time of week signal from the GPS receiver; and generate the time stamp based on the time of week signal and the periodic timing signal.

Aspect 5. The apparatus of any one of claims 1 to 4, wherein the one or more processors are further configured to: obtain first location information associated with the one or more microphones; and output the first location information and audio stream for transmission to another apparatus.

Aspect 6. The apparatus of any one of claims 1 to 5, wherein the one or more processors are further configured to: obtain first location information associated with the one or more microphones; receive, from a device, an additional audio stream with time stamps and second location information; and identify a location of an audio event based on the first location information, the second location information, the audio stream with the generated time stamp, and the additional audio stream with time stamps.

Aspect 7. The apparatus of any one of claims 1 to 6, wherein the receiver comprises a Wi-Fi receiver.

Aspect 8. The apparatus of any one of claims 1 to 6, wherein the receiver comprises a cellular receiver.

Aspect 9. The apparatus of any one of claims 1 to 8, wherein the generated time stamp is added as metadata to the audio stream.

Aspect 10. A method for audio processing comprising: receiving, from one or more microphones, an audio signal; receiving a periodic timing signal based on the periodic timing signal; combining the audio signal and the periodic timing signal into an audio stream; generating a time stamp based on the received periodic timing signal; and adding the generated time stamp to the audio stream based on the periodic timing signal in the audio stream.

Aspect 11. The method of claim 10, wherein the periodic timing signal is received from a global positioning system (GPS) receiver.

Aspect 12. The method of claim 11, wherein the periodic timing signal comprises a one pulse per second signal received by the GPS receiver.

Aspect 13. The method of any one of claim 11 or 12, further comprising: receiving a time of week signal from the GPS receiver; and generating the time stamp based on the time of week signal and the periodic timing signal.

Aspect 14. The method of any one of claims 10 to 13, further comprising: obtaining first location information associated with the one or more microphones; and outputting the first location information and audio stream for transmission to another device.

Aspect 15. The method of any one of claims 10 to 14, further comprising: obtaining first location information associated with the one or more microphones; receiving an additional audio stream with time stamps and second location information; and identifying a location of an audio event based on the first location information, the second location information, the audio stream with the generated time stamp, and the additional audio stream with time stamps.

Aspect 16. The method of any one of claims 10 to 15, wherein the periodic timing signal is received from a Wi-Fi receiver.

Aspect 17. The method of any one of claims 10 to 15, wherein the periodic timing signal is received from a cellular receiver.

Aspect 18. The method of any one of claims 10 to 17, wherein the generated time stamp is added as metadata to the audio stream.

Aspect 19. A non-transitory computer-readable medium having stored thereon instructions that, when executed by one or more processors, cause the one or more processors to: receive, from one or more microphones, an audio signal; receive periodic timing signal based on the periodic timing signal; combine the audio signal and the periodic timing signal into an audio stream; generate a time stamp based on the received periodic timing signal; and add the generated time stamp to the audio stream based on the periodic timing signal in the audio stream.

Aspect 20. The non-transitory computer-readable medium of claim 19, wherein the periodic timing signal is received from a global positioning system (GPS) receiver.

Aspect 21. The non-transitory computer-readable medium of claim 20, wherein the periodic timing signal comprises a one pulse per second signal received by the GPS receiver.

Aspect 22. The non-transitory computer-readable medium of any one of claim 20 or 21, wherein the instructions further cause the one or more processors to: receive a time of week signal from the GPS receiver; and generate the time stamp based on the time of week signal and the periodic timing signal.

Aspect 23. The non-transitory computer-readable medium of any one of claims 19 to 23, wherein the instructions further cause the one or more processors to: obtain first location information associated with the one or more microphones; and output the first location information and audio stream for transmission to another apparatus.

Aspect 24. The non-transitory computer-readable medium of any one of claims 19 to 23, wherein the instructions further cause the one or more processors to: obtain first location information associated with the one or more microphones; receive, from a device, an additional audio stream with time stamps and second location information; and identify a location of an audio event based on the first location information, the second location information, the audio stream with the generated time stamp, and the additional audio stream with time stamps.

Aspect 25. The non-transitory computer-readable medium of any one of claims 19 to 24, wherein the periodic timing signal is received from a Wi-Fi receiver.

Aspect 26. The non-transitory computer-readable medium of any one of claims 19 to 24, wherein the periodic timing signal is received from a cellular receiver.

Aspect 27. The non-transitory computer readable medium of any one of claims 19 to 26, wherein the generated time stamp is added as metadata to the audio stream.

Aspect 28. An apparatus comprising means for performing operations according to any of Aspects 1 to 27.

What is claimed is:

1. An apparatus for audio processing comprising:
a receiver configured to output a periodic timing signal;
one or more microphones;
a microphone interface coupled to the receiver and coupled to the one or more microphones, wherein the microphone interface is configured to:
receive, from the one or more microphones, an audio signal; and
receive, from the receiver, the periodic timing signal; and
one or more processors coupled to the microphone interface and coupled to the receiver, wherein the one or more processors are configured to:
combine the audio signal and the periodic timing signal into an audio stream;
generate a time stamp based on the received periodic timing signal; and
add the generated time stamp to the audio stream based on the periodic timing signal in the audio stream.

2. The apparatus of claim 1, wherein the receiver comprises a global positioning system (GPS) receiver.

3. The apparatus of claim 2, wherein the periodic timing signal comprises a one pulse per second signal output by the GPS receiver.

4. The apparatus of claim 2, wherein the one or more processors are further configured to:
receive a time of week signal from the GPS receiver; and
generate the time stamp based on the time of week signal and the periodic timing signal.

5. The apparatus of claim 1 wherein the one or more processors are further configured to:
obtain first location information associated with the one or more microphones; and
output the first location information and audio stream for transmission to another apparatus.

6. The apparatus of claim 1, wherein the one or more processors are further configured to:
obtain first location information associated with the one or more microphones;
receive, from a device, an additional audio stream with time stamps and second location information; and
identify a location of an audio event based on the first location information, the second location information, the audio stream with the generated time stamp, and the additional audio stream with time stamps.

7. The apparatus of claim 1, wherein the receiver comprises a Wi-Fi receiver.

8. The apparatus of claim 1, wherein the receiver comprises a cellular receiver.

9. The apparatus of claim 1, wherein the generated time stamp is added as metadata to the audio stream.

10. A method for processing audio data, comprising:
receiving, from one or more microphones, an audio signal;
receiving a periodic timing signal;
combining the audio signal and the periodic timing signal into an audio stream;
generating a time stamp based on the received periodic timing signal; and
adding the generated time stamp to the audio stream based on the periodic timing signal in the audio stream.

11. The method of claim 10, wherein the periodic timing signal is received from a global positioning system (GPS) receiver.

12. The method of claim 11, wherein the periodic timing signal comprises a one pulse per second signal output by the GPS receiver.

13. The method of claim 11, further comprising:
receiving a time of week signal from the GPS receiver; and
generating the time stamp based on the time of week signal and the periodic timing signal.

14. The method of claim 10, further comprising:
obtaining first location information associated with the one or more microphones; and
outputting the first location information and audio stream for transmission to another device.

15. The method of claim 10, further comprising:
obtaining first location information associated with the one or more microphones;
receiving an additional audio stream with time stamps and second location information; and
identifying a location of an audio event based on the first location information, the second location information, the audio stream with the generated time stamp, and the additional audio stream with time stamps.

16. The method of claim 10, wherein the periodic timing signal is received from a Wi-Fi receiver.

17. The method of claim 10, wherein the periodic timing signal is received from a cellular receiver.

18. The method of claim 10, wherein the generated time stamp is added as metadata to the audio stream.

19. A non-transitory computer-readable medium having stored thereon instructions that, when executed by one or more processors, cause the one or more processors to:
receive, from one or more microphones, an audio signal;
receive a periodic timing signal;
combine the audio signal and the periodic timing signal into an audio stream;
generate a time stamp based on the received periodic timing signal; and
add the generated time stamp to the audio stream based on the periodic timing signal in the audio stream.

20. The non-transitory computer-readable medium of claim 19, wherein the periodic timing signal is received from a global positioning system (GPS) receiver.

21. The non-transitory computer-readable medium of claim 20, wherein the periodic timing signal comprises a one pulse per second signal received by the GPS receiver.

22. The non-transitory computer-readable medium of claim 20, wherein the instructions further cause the one or more processors to:
receive a time of week signal from the GPS receiver; and
generate the time stamp based on the time of week signal and the periodic timing signal.

23. The non-transitory computer-readable medium of claim 19, wherein the instructions further cause the one or more processors to:
obtain first location information associated with the one or more microphones; and
output the first location information and audio stream for transmission to another apparatus.

24. The non-transitory computer-readable medium of claim 19, wherein the instructions further cause the one or more processors to:
obtain first location information associated with the one or more microphones;
receive, from a device, an additional audio stream with time stamps and second location information; and
identify a location of an audio event based on the first location information, the second location information, the audio stream with the generated time stamp, and the additional audio stream with time stamps.

25. The non-transitory computer-readable medium of claim 19, wherein the periodic timing signal is received from a Wi-Fi receiver.

26. The non-transitory computer-readable medium of claim 19, wherein the periodic timing signal is received from a cellular receiver.

27. The non-transitory computer-readable medium of claim 19, wherein the generated time stamp is added as metadata to the audio stream.

28. An apparatus for processing audio data, the apparatus comprising:
means for receiving, from one or more microphones, an audio signal;
means for receiving a periodic timing signal;
means for combining the audio signal and the periodic timing signal into an audio stream;
means for generating a time stamp based on the received periodic timing signal; and
means for adding the generated time stamp to the audio stream based on the periodic timing signal in the audio stream.

29. The apparatus of claim 28, wherein the periodic timing signal comprises a one pulse per second signal.

30. The apparatus of claim 28, further comprising:
means for receiving a time of week signal; and
means for generating the time stamp based on the time of week signal and the periodic timing signal.
